(19) United States
(12) Patent Application Publication
(10) Pub. No.: US 2006/0182235 A1
(43) Pub. Date: Aug. 17, 2006

(54) Mobile communication terminal and method

(76) Inventors: Christian Kraft, Frederiksberg (DK); Peter Dam Nielsen, Lyngby (DK)

Correspondence Address: PERMAN & GREEN, 425 POST ROAD, FAIRFIELD, CT, 06824, US

(21) Appl. No.: 11/048,089

(22) Filed: Feb. 1, 2005

(51) Int. Cl. H04M 11/00

(52) U.S. Cl. 379/88.14

(57) ABSTRACT

A method for sending messages from a mobile communication apparatus, including the steps of determining a message text; converting the message text to an audio signal including speech; and sending the audio signal to a receiver by a short audio message, and a computer program for performing the method. Further, a mobile communication apparatus including a text-to-speech generator for generating synthetic speech corresponding to a message text; a short audio messaging generator for inserting the synthetic speech into a short audio message; and a transmitter for sending the short audio message is disclosed.

### BACKGROUND OF THE INVENTION

1. Field of the Invention

The present invention relates to a method for sending messages from a mobile communication apparatus, a mobile communication apparatus, and a computer program.

2. Brief Description of Related Developments

In the document ‘Short Audio Messaging—New low cost voice communication service’, published 2003 by Nokia Corporation and here incorporated by reference, a messaging service called Short Audio Messaging (SAM) is disclosed where audio clips are sent as messages. Thus, messaging from a mobile communication apparatus is further improved by SAM. However, there is a need for improved handling of this messaging service in the mobile communication apparatus.

### SUMMARY OF THE INVENTION

It is therefore an object of the present invention to provide improved integration of SAM in a mobile communication apparatus.

The above object is provided according to a first aspect of the present invention by a method for sending messages from a mobile communication apparatus, comprising the steps of: determining a message text; converting said message text to an audio signal comprising speech; and sending said audio signal to a receiver by a short audio message.

The text may be extracted from an SMS, an e-mail, a list of missed calls, one or more bookmarks, a reminder, a notification, or a calendar item.

The method may furter comprise the step of editing the message text.

An advantage of this aspect of the present invention is that originally text based information is provided to a user through short audio messaging (SAM), which is particularly advantageous for receivers that are not able to read a text message, e.g. vision-impaired users, users driving a car, craftsmen at work, persons with no or little reading skills, etc. A further advantage is that the receiving side only need capability to receive a SAM. Only the sending side need capability to do text-to-speech conversion.

The above object is provided according to a second aspect of the present invention by a mobile communication apparatus comprising a text-to-speech generator for generating synthetic speech corresponding to a message text; a short audio messaging generator for inserting said synthetic speech into a short audio message; and a transmitter for sending said short audio message.

The mobile communication apparatus may further comprise a parser arranged to determine said message text from an SMS, an e-mail, a list of missed calls, one or more bookmarks, a reminder, a notification, or a calendar item.

The mobile communication apparatus may further comprise a text editor arranged to edit the message text.

An advantage of this aspect of the present invention is that text based information is converted to synthetic speech and provided to a user through a SAM, thus providing improved messaging to receivers not able to read text messages, e.g. vision-impaired users, users driving a car, craftsmen at work, person with little or no reading skills, etc. Another advantage is for persons that is not used to text based applications and services in the telephone, or just prefer spoken messages. The application or service will thus be presented through the synthetic speech to the recipient. On the sending side, only the option to send a message by SAM is to be chosen. Less training is required for the unexperienced user, and an improved messaging is experienced by the users.

Other advantages of the second aspect of the invention are similar to those of the first aspect of the invention.

The above object is provided according to a third aspect of the present invention by a computer program arranged to perform the method according to the first aspect of the present invention when downloaded into and run on a mobile communication apparatus.

An advantage of this is that the features of the present invention are enabled in any mobile communication apparatus having the ability to download and run such a computer program.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 is a flow chart of an embodiment of the present invention; and

FIG. 2 schematically illustrates a mobile communication apparatus.

### DETAILED DESCRIPTION OF THE PREFERRED EMBODIMENT

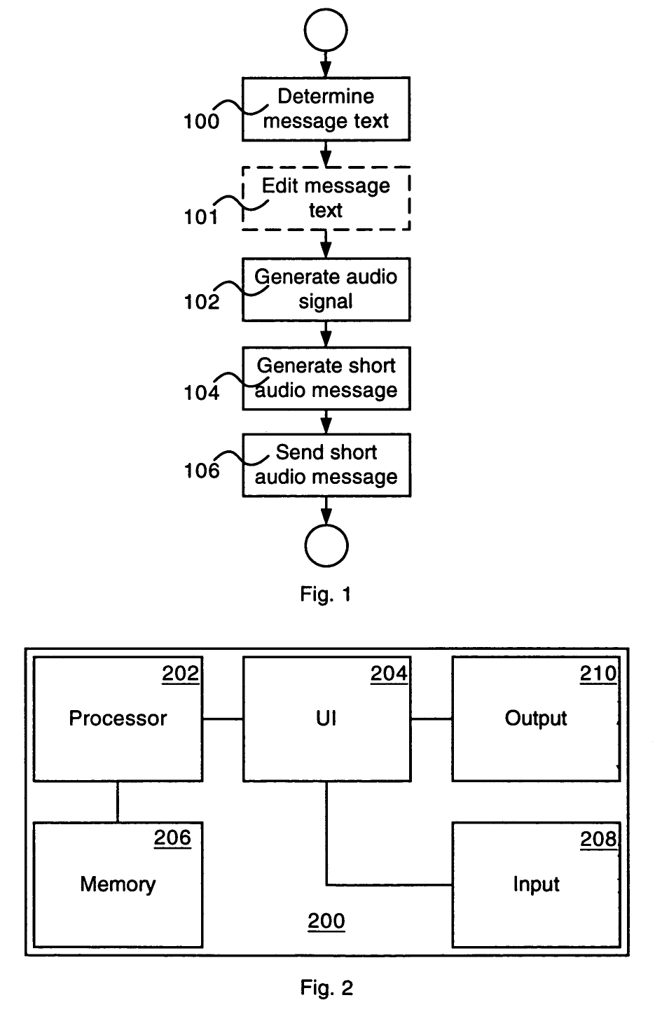

FIG. 1 is a flow chart of an embodiment of the present invention. In a message text determination step 100, a text associated with an item of an application in a mobile communication apparatus is determined. The item can be a text message such as an SMS (Short Message Service), e-mail or calendar appointment, or any other item, which comprises text that a user wants to insert into a message, such as a caller ID, phone setting, call log, battery warning, personal contact list, or is related to a user interface generated text associated with an application.

A synthetic speech corresponding to the message text determined in the message text determination step 100 is generated in an audio signal generation step 102. Optionally, the message text can be edited or created in a text editing step 101. The synthetic speech is inserted as information part in message according to short audio messaging (SAM) in a short audio message generation step 104. SAM is a messaging service which transmits audio messages as packet switched data within a cellular radio communication system. For example, the message is sent to a receiver by a general packet radio service (GPRS). In this way, the short audio message is sent in a sending step 106.

An example where this is feasible is when a receiver of a message has low reading skills, e.g. a child. Another example is when a message, e.g. an SMS, is to be sent, or forwarded, to a friend that is vision-impaired. The use of SAM will facilitate messaging for the receivers in these cases, and the improved messaging handling according to the present invention will facilitate for the sender to choose which kind of messaging service to use. It is possible to communicate the message as described above to one or more mobile communication apparatuses.

A special feature of this invention is that only the mobile communication apparatus initiating the communication needs any modifications compared to a normal phone. The receiving apparatuses only need capability to receive SAM.

FIG. 2 schematically shows a mobile communication apparatus 200 according to an embodiment of the present invention. It should be noted that parts not contributing to the core of the invention are left out not to obscure the features of the present invention. The mobile communication apparatus comprises a processor 202, a user interface (UI) 204, and a memory 206. The memory 206 holds, among other things, program code for operation of applications of the mobile communication apparatus. The memory 206 also holds data used by the applications. Here, the memory 206 is depicted as a single unit. However, the memory can be two or more units, and/or divided in partitions. Examples of applications relevant for the understanding of the present invention are text-to-speech generator, parser, and the application from which the message text emanates, e.g. a calendar application or a text message service application. Preferably, program code for applications can be downloaded to the memory 206, and the downloaded program code can then be executed by the processor 202. The mobile communication apparatus can also comprise a text editor, which is one of the applications run by said processor 202 and experienced by a user through the UI 204.

The user interface 204 comprises an input 208 and an output 210. The input 208 can comprise a keypad, keyboard, wheelpad, and/or speech controlled input. The output 210 can comprise a speaker, headset, display, buzzer, and/or vibrator.

The function of the invention in the mobile communication apparatus will be described below by an illustrative example, from which also other operation scenarios will be easily understood by the artisan.

A short message service (SMS) application is run on the processor 202. The outbox of the application comprises one or more messages to be sent. A message comprises a text and a recipient indicator. Program code in the memory 206 for messaging services is run simultaneously on the processor 202, which causes the processor 202 to determine a message text, which is the text of the SMS. The mobile communication apparatus can also comprise a text editor enabling a user to edit the message text. The message text can also be created by means of the text editor. The processor 202 generates an audio signal by running a text-to-speech application, which generates a synthetic voice message, which is used to generate a SAM, which then can be transmitted to the recipient.

In the example above, the text can be determined by a parser parsing the information text to find information that is relevant to the message. The message containing the text can be an edited, received or stored text message, an e-mail, a list of missed calls, etc.

Another example is when a text message is to be forwarded to a vision-impaired person. The information text of the text message is determined, and information about the sender and/or forwarder and, preferably, some information that it is a text message converted to speech is added to the information text to form a notification text. A SAM is generated and sent to the vision-impaired person's telephone, and when the person receives it, the message emanating from the text is rendered by the synthetic voice inserted in the SAM to the vision impaired person.

1. A method for sending messages from a mobile:
communication apparatus, comprising the steps of:
determining a message text;
converting said message text to an audio signal comprising speech; and
sending said audio signal to a receiver by a short audio message.

2. The method according to claim 1, wherein said step of determining a message text comprises the step of extracting the text from an SMS, an e-mail, a list of missed calls, one or more bookmarks, a reminder, a notification, or a calendar item.

3. The method according to claim 1, further comprising the step of editing said message text.

4. A mobile communication apparatus comprising a text-to-speech generator for generating synthetic speech corresponding to a message text;
a short audio messaging generator for inserting said synthetic speech into a short audio message; and
a transmitter for sending said short audio message.

5. The mobile communication apparatus according to claim 4, further comprising a parser arranged to determine said message text from an SMS, an e-mail, a list of missed calls, one or more bookmarks, a reminder, a notification, or a calendar item.

6. The mobile communication apparatus according to claim 4, further comprising a text editor arranged to edit said message text.

7. A computer program arranged to perform the method according to claim 1 when downloaded into and run on a mobile communication apparatus.
